(19) United States
(12) Patent Application Publication
(10) Pub. No.: US 2011/0207389 A1
(43) Pub. Date: Aug. 25, 2011

(54) MEAT TENDERIZER

(76) Inventor: Leonard Deni, Buffalo, NY (US)

(21) Appl. No.: 12/709,975

(22) Filed: Feb. 22, 2010

(51) Int. Cl. A22C 9/00

(52) U.S. Cl. 452/145

(57) ABSTRACT

A hand operated meat tenderizer comprising a generally semicircular housing having an elliptical horizontal cross-section opening with an axle mounted across the opening. A rotary blade assembly comprising at least one blade segment is arranged on a common axis on the axle There is further a means for retractably shielding the blade assembly.

### BACKGROUND OF THE INVENTION

1. Field of the Invention

This invention relates to meat tenderizers. More particularly, the invention relates to a compact, hand-held mechanical meat tenderizer which uses a series of knives arranged around a common axle that imparts a tenderizing action on a piece of meat as the tenderizer is rolled across the meat's surface.

2. Background

Several devices have been invented to mechanically tenderize meat. These devices generally operate using one of two principles—either plunging of the tenderizing functionality into the meat or rolling of a spiked spindle across the meat. Early meat tenderizers used a mallet with a figured or spiked head. The user would strike the meat forcing the tenderizing elements to puncture the meat. Recent improvements on this concept are found in U.S. Pat. Nos. 7,182,685 issued to Gorowski, 4,199,841 issued to Jaccard, and D545,644 issued to Deni, all of which place the striking elements within a spring-loaded handle. The user pounds the meat with the handle which compresses a spring causing the blades to extend into the meat. As the user lifts the apparatus, the spring relaxes and the blades retract into the handle increasing user safety. One advantage of this approach is the tenderizer can be used in one hand, while the other hand handles the raw meat. One-handed operation minimizes the opportunities for contaminating the work area with harmful bacteria. However, this striking of the meat leads to user fatigue as the tenderizer must be lifted and transferred to another portion of the meat to repeat the piercing process while also causing the natural juices to be forced out of the meat yielding a less tender final product.

Examples of the second approach to mechanical meat tenderizers—rolling pins—are found in U.S. Pat. Nos. 6,159,090 issued to Thompson and D365,971 issued to Brockman. This approach modifies a smooth pastry rolling pin by replacing the smooth portion with a figured or spiked portion between the two handles. This type of tenderizer is less strenuous on a user as it is easier to roll the pin back and forth rather than lifting and plunging as with the striking type tenderizers. Rolling also minimizes the amount of downward force applied to the meat allowing more of the natural juices to remain within the meat leading to a more tender final product. However, this rolling pin apparatus requires two hands for proper operation, leading to an increased chance of contamination from touching the raw meat and then handling the rolling pin handle. U.S. Pat. Nos. 4,380,850 issued to Coburn and D481,268 issued to Hibbert modify the two-handed roller by adding a handle such that the roller looks more like a stirrup. The user is then able to operate the tenderizer with one hand. However, disadvantages of any of the rolling pin-based tenderizers are their bulk (requiring a lot of space in a kitchen drawer) and the possibility of owner injury because, even when not in use the tenderizing elements (spikes or knives) are unsecured raising the chance that an owner may be cut or punctured by inadvertently touching or grabbing the tenderizer.

Thus it is readily apparent that there is a long felt need for a compact, single-hand operated, rolling meat tenderizer which can be safely used and stored which also minimizes possibilities of bacterial contamination.

### SUMMARY OF THE INVENTION

It is accordingly a primary object of the present invention to provide a compact, single-hand-operated rolling meat tenderizer for use in home kitchens.

Another object of the invention is to provide a rolling meat tenderizer which tenderizes the meat by using a plurality of discs, each of which contains numerous knife edges to puncture the meat.

A further object of the invention is to provide a compact rolling meat tenderizer possessing a cover which protects the owner from injury during use and also a protective cap for the knife-edged discs for use when the tenderizer is in storage.

The above and other objects are accomplished in accordance with the present invention which comprises a compact, hand-held mechanical meat tenderizer having a first generally semicircular housing formed of two components having a diameter and thickness to fit comfortably in a user's hand. An axle is located at the center of the housing's diameter and has a plurality of disc shaped blades with each disc having numerous knife edges and being spaced roughly evenly apart upon the axle. A spring-loaded comb is mounted onto the housing for being slidably movable into and out of the housing and contains a plurality of flow through grooves for passage of the disc shaped blades. Preferably, a second generally semicircular housing which complements the first housing to form a completed circle is removably affixed to the first housing to protect the user from injuries and the knife edges from damage while the tenderizer is in storage.

### BRIEF DESCRIPTION OF THE DRAWINGS

The present invention and the manner in which it may be practiced is further illustrated with reference to the accompanying drawings wherein:

FIG. 1 is a perspective view of one embodiment of a meat tenderizing device of the present invention.

FIG. 2 is a side view of one embodiment of a meat tenderizing device of the present invention showing the blade cover being removed.

FIG. 3 is an end view of one embodiment of a meat tenderizing device of the present invention, taken generally along line 3-3 of FIG. 2.

FIG. 4 is a bottom view of one embodiment of a meat tenderizing device of the present invention, taken generally along line 4-4 in FIG. 3.

FIG. 5 is an exploded view of one embodiment of a meat tenderizing device of the present invention.

FIG. 6 is a perspective view the wheel assembly of one embodiment of a meat tenderizing device of the present invention.

FIG. 7 is a cross-sectional view of one embodiment of a meat tenderizing device of the present invention showing the spring-loaded comb in a down position, taken generally along line 7-7 in FIG. 3.

FIG. 8 is a cross-sectional view of one embodiment of a meat tenderizing device of the present invention showing the spring-loaded comb in an up position, as when the device is being used.

FIG. 9 is an illustrative example of one embodiment of a meat tenderizing device of the present invention just prior to being used for tenderizing.

FIG. 10 is an illustrative example of one embodiment of a meat tenderizing device of the present invention being used for tenderizing.

### DETAILED DESCRIPTION OF THE INVENTION

At the outset, it should be clearly understood that like reference numerals are intended to identify the same structural elements, portions, or surfaces consistently through out the several drawing figures, as may be further described or explained by the entire written specification of which this detailed description is an integral part. The drawings are intended to be read together with the specification and are to be construed as a portion of the entire “written description” of this invention as required by 35 U.S.C. §112.

The meat tenderizing device of the present invention is suitable as a rolling style single-hand operated mechanical meat tenderizer. In operation, the protective housing of the meat tenderizer is removed to expose the spring-loaded comb. While holding the blade housing, the spring-loaded comb rests on the surface of the meat. Pressure is then applied to the housing allowing the comb to recede into the blade housing and expose the knife edges. The knife edges penetrate the meat. The housing is then rolled across the meat surface causing the knife blades to rotate on the blade axle as the tenderizer is rolled. Successive knife edges pierce the meat as the tenderizer is rolled along the meat surface. Rolling the device allows the knives to puncture the meat without tearing or gouging the meat surface. When the user lifts the tenderizer from the meat, the tension on the springs is released from the comb and the comb re-covers the knife edges. Preferably, the tenderizer housing and axle are constructed of a durable plastic or lightweight metal such as aluminum while the disc blades and knife edges are made of a rigid material capable of maintaining a sharp edge such as stainless steel.

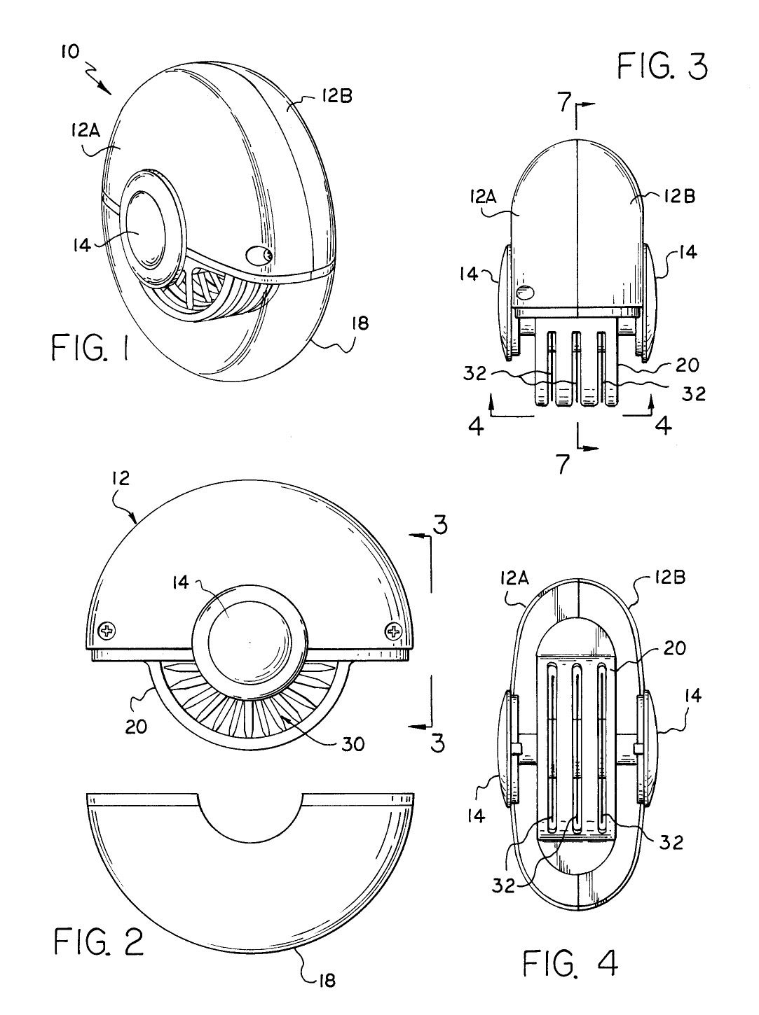

Adverting now to the drawings, with reference to FIGS. 1 and 2, a preferred embodiment of the present invention is indicated generally by numeral 10 showing a meat tenderizer with a generally semicircular blade housing with an additional lobe formed of two components 12a and 12b (collectively blade housing 12), circular axle covering 14, blade assembly 30, a spring-loaded comb 20 mounted within the blade housing operatively arranged to be slidably movable into and out of the blade housing and possessing a plurality of flow through grooves for passage of the disc shaped blades, and optionally, a complementary generally semicircular blade covering 18. Circular axle covering 14 conceals and protects the junction between housing 12 and blade assembly 30.

FIGS. 3 and 4 show different views of a preferred embodiment of a meat tenderizer of the present invention. FIG. 3 is an end view of one embodiment of a meat tenderizing device of the present invention, taken generally along line 3-3 of FIG. 2. FIG. 4 is a bottom view of one embodiment of a meat tenderizing device of the present invention, taken generally along line 4-4 in FIG. 3.

FIG. 3 is an end view while FIG. 4 is bottom view of a preferred embodiment of a meat tenderizer of the present invention. As shown, the blade housing is comprised of two halves 12A and 12B having a rounded-over top edge. During use, spring-loaded comb 20 is pushed upward into blade housing 12 exposing the knife blades 32 of the tenderizer. The ergonomic rounded edge increases user comfort and safety when holding the blade housing during use. When the device is pushed toward the meat during use there are no sharp edges pressing against the user's hand. Circular axle coverings 14 project exterior the blade housing and cover the fastening means of the axle to the blade housing (not shown). Circular axle coverings 14 are aesthetic appendages and are not required for proper functioning of the tenderizer. The semicircular housing 12 is ergonomically shaped with a generally elliptical horizontal cross-section and is designed to fit comfortably in a user's hand. It should be understood by those skilled in the art that meat tenderizers can be constructed having other shapes, but that the semicircular shape of the preferred embodiment was chosen to maximize user comfort while simultaneously minimizing storage space requirements.

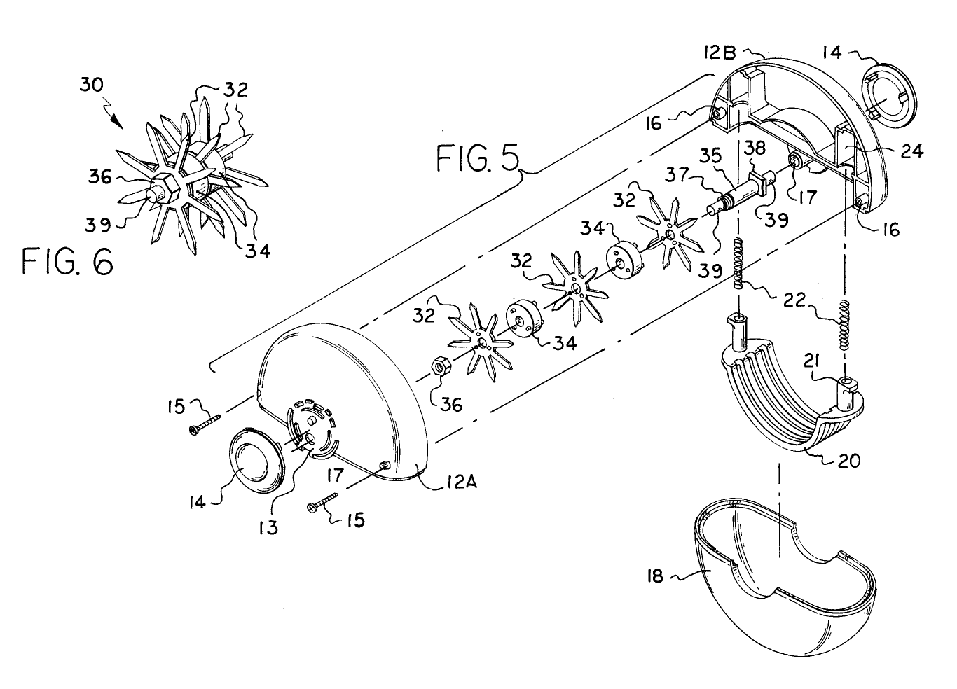

FIG. 5 is an exploded view of a preferred embodiment of a meat tenderizer of the present invention. The blade housing is composed of two generally semicircular halves 12A and 12B which are attached by threading screws 15 through a hole on first semicircular half 12A into a corresponding receptacle 16 on second semicircular half 12B. Although screws are used to hold the two halves together, it should be understood that other fastening means can be used, such as but not limited to a clip and groove arrangement or a glue or cement. When combined, the blade housing forms a shell having an elliptical cross section. Each half 12A and 12B has an additional semicircular lobe 13 depending downwardly from the straight edge diameter of each half 12A or 12B. Semicircular lobe 13 has a smaller diameter than 12A or 12 B and possesses the same center point as the larger semicircle. Each lobe 13 has a through-hole 17 through which passes axle end shaft 39. Circular covering 14 snaps onto each half of blade housing and covers through-hole 17. Covers 14 are aesthetic appendages and are not required for proper functioning of the tenderizer. When combined, 12A and 12B create channel 24 which houses spring 22. Extension 21 of spring-loaded comb 20 is operatively arranged to slide within channel 24. Spring loaded comb 20 contains flow through grooves for passage of knife blades 32 during use of the meat tenderizer. Semicircular blade covering 18 complements the blade housing 12 to form a completed circle and is removably affixed to the blade housing to protect the user from injuries and the knife edges from damage while the tenderizer is in storage. In as further depicted in the view of FIG. 6, blade assembly 30 comprises axle 35 having a fixed nut 38 proximate one end and threaded portion 37 proximate the other end. Axle 35 has threadless cylindrical extensions 39 at each end which fit operatively within holes 17 of blade housing 12 such that axle 35 will rotate freely during use of the meat tenderizer. Threaded nut 36 is positioned onto the threaded portion 37 and, in conjunction with fixed nut 38, prevents knife blades 32 and spacers 34 from moving laterally along axle 35.

FIG. 6 shows blade assembly 30 as a complete unit. Knife blades 32 alternate with spacers 34. In one embodiment, three knife blades and two spacers are used. However, it is envisioned that any number of blades and spacers can be used depending on the width of the blade housing and thickness of the blades and spacers. In one preferred embodiment, the axle shaft is cylindrical in shape with a round external surface. Knife blades 32 and spacers 34 can contain a round internal through-bore which slides over the shaft. The round shaft and round through-bore allow each of the knife blades to rotate on the shaft individually. In a separate embodiment, the axle shaft (apart from smooth cylindrical portions 39) has a polygonal (preferably hexagonal) external surface. The knife blades 32 and spacers 34 have a corresponding through-bore which slides over the shaft. The non-round shaft prevents the knife blades from rotating individually. The knife blades will turn as a single unit as the roller is moved across the surface of the meat.

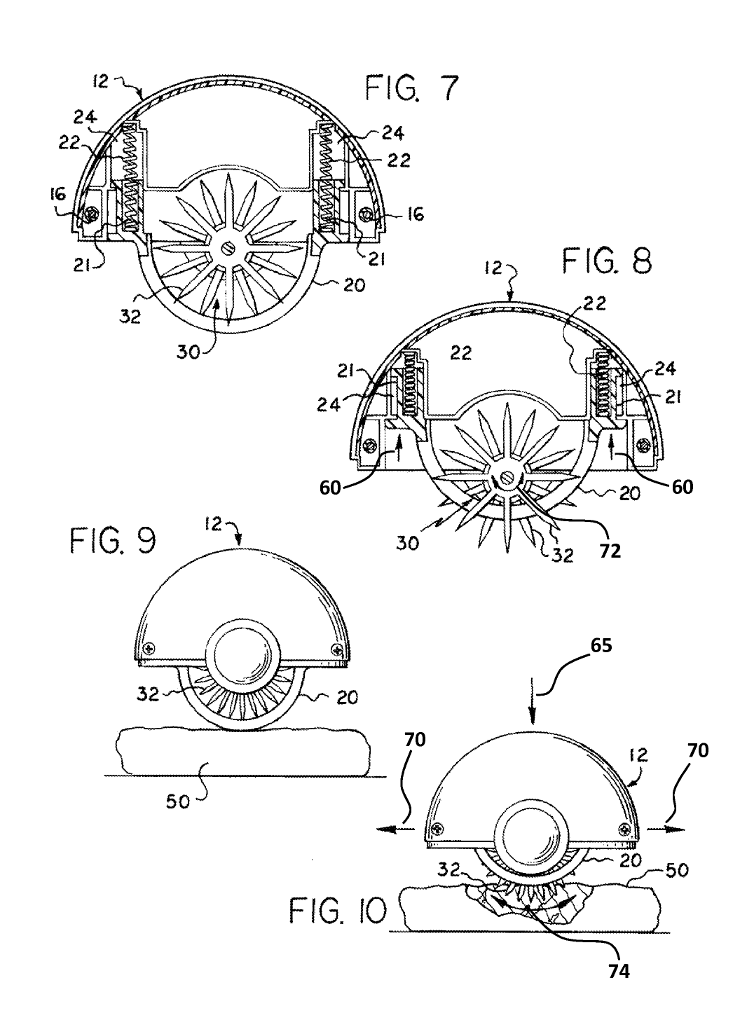

As shown in FIGS. 7 and 8, spring-loaded comb 20 extends into blade housing 12 and rests within channel 24. FIG. 7 is a cross-sectional view of one embodiment of a meat tenderizing device of the present invention showing the spring-loaded comb in a down position, taken generally along line 7-7 in FIG. 3. Spring 22 is positioned within channel 24 and passes into a channel formed within the comb's extension. Spring-loaded comb 20 is free to float within channel 24. In use, downward pressure, illustrated by arrow 60 in FIG. 8, is exerted on housing 12 causing comb 20 to compress spring 22. This spring compression causes comb 20 to partially enter channel 24 thereby exposing the edges of knife blades 32 as the blades pass through the flow through grooves in the comb as shown in FIGS. 8 and 10. When the tenderizer is not in use, spring 22 is relaxed allowing comb 20 to cover the tips of the knife blades 32 as shown in FIGS. 7 and 9.

FIGS. 9 and 10 illustrate a meat tenderizer of the present invention just prior to use (FIG. 9) and during use (FIG. 10). As shown in FIG. 9, blade housing 12 is positioned so that comb 20 rests on the surface of the meat 50. Comb 20 covers knife blades 32. During use, as shown in FIG. 10, blade housing 12 is pushed downwardly, as shown by arrow 65, and comb 20 is directed upwardly into blade housing 12 by compressing springs (shown in FIG. 8). The upward movement of comb 20 exposes the edges of knife blades 32, and combined with the downward pressure on blade housing 12, presses the edges of knife blades 32 into the meat surface 50. Moving blade housing 12 back and forth, as shown by arrows 70, causes the axle/blade assembly to rotate on the axle, as shown in FIG. 8 by arrow 72 and arrow 74 in FIG. 10. The rotation of the axle allows successive knife edges to penetrate and tenderize the meat surface.

In operation, minimal downward pressure is needed to expose the knife edges and cause them to penetrate the meat. The minimally-applied pressure alleviates loss of the natural fluids found in the meat allowing for a more tender and flavorful product. The successive knife edges prevent tearing of the surface as the meat is tenderized. After use, as pressure is removed from blade housing 12, the stored energy in the compressed springs (shown in FIG. 8) is released causing comb 20 to return to its relaxed position covering the knife blades 32 (shown in FIG. 7). Thus, when not in use the sharp edges of the knives are covered, preventing a user from accidentally cutting or puncturing himself or herself while also protecting the sharp edges from damage. For added security, the blade covering (as shown in FIGS. 2 and 3) can be employed, particularly during storage in a kitchen drawer.

Although the invention has been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

1. A hand operated meat tenderizer comprising:
a generally semicircular housing having an elliptical horizontal cross-section opening;
an axle mounted across said opening;
a rotary blade assembly comprising at least one blade segment arranged on a common axis on said axle; and
a retractable spring-loaded comb mounted onto said housing operatively arranged to retractably shield said blade assembly and adapted to resiliently move horizontally toward and away from said housing in such a manner so that as said retractable spring-loaded comb moves horizontally toward said housing, said at least one blade segment is free to rotate on said axle and extend radially outward through at least one flow-through groove in said comb when the tenderizer is moved vertically across a surface, and wherein the comb shields said at least one blade segment in said away position from said housing.

2. (canceled)

3. The meat tenderizer of claim 1 further comprising a covering removably affixed to said housing.

4. The meat tenderizer of claim 1 wherein said at least one blade segment is a plurality of blades and spacers arranged on said axle wherein said spacers and said blades alternate along said axle.

5. The meat tenderizer of claim 4 wherein said plurality of blades comprise a plurality of knife-edged projections.

6. A hand operated meat tenderizer comprising:
a generally semicircular housing having an elliptical horizontal cross-section wherein said elliptical cross-section has a minor axis and a major axis;
a pair of generally semicircular lobes depending downwardly from said housing wherein said lobes have a diameter roughly one quarter that of said housing, and wherein said lobes and said housing share a common center point;
an axle operatively attached to said lobes and said housing at said center point and traversing said minor axis of said elliptical cross-section;
a blade assembly comprising at least two independently rotating blade segments arranged on said axle; and
a retractable spring-loaded comb mounted to said housing operatively arranged to retractably shield said blade assembly; wherein said spring-loaded comb is adapted to resiliently move horizontally toward and away from said housing in such a manner so that as said movable spring-loaded comb moves horizontally toward said housing, said at least two independently rotating blade segments are free to rotate on said axle and extend radially outward through a plurality of flow-through grooves in said comb when the tenderizer is moved vertically across a surface, and wherein the comb shields said blade assembly in said away position from said housing.

7. The meat tenderizer of claim 6 further comprising a covering removably affixed to said housing and said lobes wherein said covering complements said housing and said lobes to form a completed circle.

8. The meat tenderizer of claim 6 wherein said blade assembly is comprised of at least one blade segment wherein each blade segment is comprised of a blade and a at least one spacer arranged on said axle wherein said blade and said at least one spacer alternate along said axle.

9. The rolling meat tenderizer of claim 8 wherein each of said at least two blade segments comprise a plurality of knife-edged projections.

10. (canceled)
